(19) United States
(12) Patent Application Publication
(10) Pub. No.: US 2007/0294141 A1
(43) Pub. Date: Dec. 20, 2007

(54) Method and Device for Aiding Consumers in the Selection of Infant Clothing

(76) Inventors: Eric Bublitz, Franklin, WI (US); Michaela Bublitz, Franklin, WI (US)

Correspondence Address: Eric Bublitz, 8900 North Arbon Drive, Milwaukee, WI, 53223, US

(21) Appl. No.: 11/747,283

(22) Filed: May 11, 2007

Related U.S. Application Data
(60) Provisional application No. 60/804,929, filed on Jun. 15, 2006.

(51) Int. Cl. G06F 17/30

(52) U.S. Cl. 705/27

(57) ABSTRACT

The subject invention relates to a method and a device for aiding users in determining the correct correspondence between infant clothing size and meteorological season, based on infant birth date. The method includes using an infant clothing sizing chart with a plurality of rows that correspond to an infant birth date and a plurality of rows that correspond to one of a meteorological season or an infant clothing size. The user cross-references a row and a column of interest to find a point, or cell, or intersection, wherein the point, or cell, of intersection indicates either the appropriate size or season for which infant clothing should be purchased. The subject device, on the other hand, receives user input related to the infant's birth date and one of the meteorological season or the infant clothing size, manipulates the inputted data, and outputs either the appropriate size or season for which infant clothing should be purchased.

### BACKGROUND OF THE INVENTION

1. Field of the Invention

The present invention relates to a method and device for aiding consumers in determining the correct correspondence between infant clothing size and meteorological season, based on infant birth date or expected birth date.

2. Description of the Related Art

Consumers of infant clothing commonly encounter difficulty in selecting the correct clothing size for a meteorological season (i.e., winter, spring, summer, fall), based on the infant's birth date or expected birth date. Many retailers of infant clothing do not offer for sale infant clothing for all seasons simultaneously, instead only offering clothing for one or two seasons at any given time. Because infant clothing sizes are based on the infant's age (e.g., 0-3 months, 3-6 months, etc.) and an infant grows so rapidly, this arrangement requires a consumer to determine how old the infant will be during the season for which clothing is currently being offered. For a variety of reasons this determination is difficult for many consumers, particularly consumers who have no children but are nevertheless shopping for infant clothing as a gift (often for baby showers) or for newly-expectant parents. As a result, the consumer often ends up purchasing the wrong-sized clothing for a given season, which can be embarrassing for the consumer and inconvenient for the retail store because it has to deal with returned merchandise.

The applicants have come across no prior devices, systems, or methods that address this specific problem. Prior attempts to aid consumers in selecting appropriately sized infant clothing have, not surprisingly, related the clothing size to the size (length and weight) of the infant.

Therefore, a need still exists for a device, system, or method that aids consumers of infant clothing by relating clothing size to season, based on the infant's birth date (or expected birth date).

### SUMMARY OF THE INVENTION

In order to provide a simple, inexpensive device for aiding consumers in selecting the correct size of infant clothing for a particular meteorological season, the method and device disclosed relate infant clothing size to season, based on the infant's birth date or the mother's due date. In some embodiments, this objective is accomplished by a device that includes a chart with a series of rows corresponding to the birth or due date and a series of columns corresponding to the clothing size. A method of using the device includes cross-referencing the appropriate row and the appropriate column to find a point of intersection that indicates the correct meteorological season for which to purchase the infant clothing.

In other embodiments, the above objective is accomplished by a method and device that include a chart with multiple rows corresponding to the birth or due date and multiple columns corresponding to the meteorological season. In these embodiments, a method of use includes cross-referencing the appropriate row and the appropriate column to find a point of intersection that indicates the correct infant clothing size to purchase.

In yet other embodiments, the above objective is accomplished by an electronic apparatus that receives user input related to the infant's birth date (or anticipated birth date) and one of (a) the size of clothing to be purchased or (b) the season the clothing is to be purchased for. Based on the user's input, the apparatus will output one of (a) the correct season to purchase the clothing for or (b) the correct size of infant clothing to be purchased.

While a variety of different embodiments have been generally discussed for achieving the goals outlined above, neither this summary nor the following detailed description purports to define the invention. The invention is defined by the claims.

### BRIEF DESCRIPTION OF THE DRAWINGS

FIG. 1 is an isometric view of a point-of-purchase display with a chart that aids consumers of infant clothing in selecting the correct clothing size, by relating clothing size to meteorological season, based on the infant's birth date (or expected birth date).

FIG. 2 is a front view of a portable means for displaying a chart that aids consumers of infant clothing in selecting the correct clothing size, by relating clothing size to meteorological season, based on the infant's birth date (or expected birth date).

FIG. 3 shows the sizing chart of FIGS. 1 and 2, wherein the infant's birth date can be cross-referenced against the meteorological season to give the user the correct clothing size.

FIG. 4 is similar to FIG. 3 but showing another embodiment of the sizing chart, wherein the clothing sizes are color coded.

FIG. 5 is similar to FIG. 3 but showing a sizing chart in which the infant's birth date can be cross-referenced against the clothing size to give the user the correct season to purchase clothing for.

FIG. 6 is similar to FIG. 5 but showing another embodiment of the sizing chart, wherein the seasons for which clothing should be purchased are color coded.

FIG. 7 is an isometric view of an electronic version of a point-of-purchase display, including a means for electronically displaying either the correct season or the correct clothing size based on user input of either the season or the clothing size.

FIG. 8 is similar to FIG. 7, but showing another embodiment of the electronic point-of-purchase display, wherein a single input means is used to gather user input.

FIG. 9 is block diagram of the electronic version of the point-of-purchase display of FIG. 7 or 8.

FIG. 10 is a flowchart depicting the operational steps carried out by the processor of the electronic point-of-purchase display of FIG. 7 or FIG. 8.

### DETAILED DESCRIPTION OF AN EXAMPLE

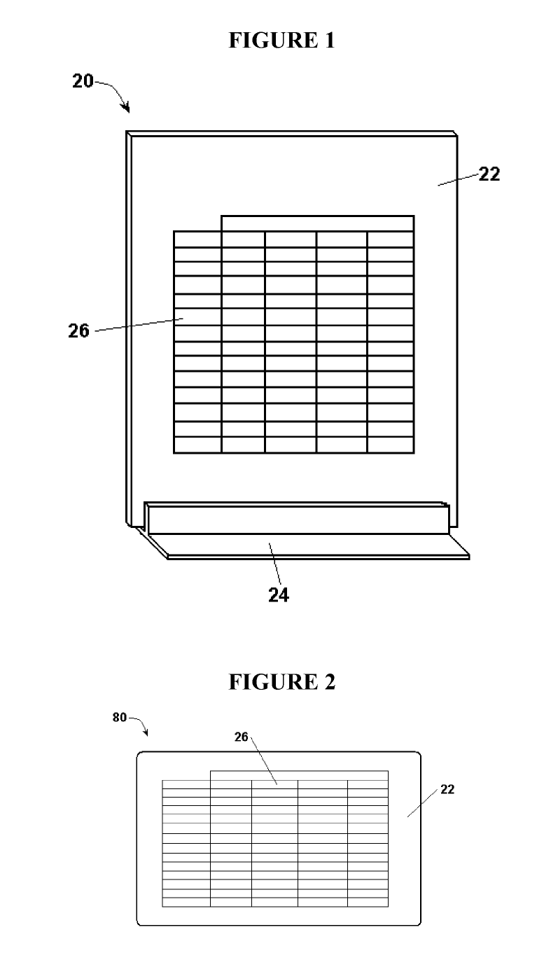

FIG. 1 shows a point-of-purchase display 20 that can be used in the vicinity of infant clothing in a retail store. Point-of-purchase display 20 may include a carrier 22, such as cardboard, paper, plastic, or the like, upon which an infant clothing size chart 26 is disposed. Point-of-purchase display 20 may also include a support base 24 for maintaining carrier 22 in a generally upright position, clearly visible to a customer.

FIG. 2 illustrates another use of infant clothing size chart 26, wherein size chart 26 is included on a smaller, more portable card 80. Carrier 22 may, again, comprise cardboard, paper, plastic, or the like. Portable card 80 will include infant clothing size chart 26 disposed on carrier 22. Although the specific size and shape of portable card 80 may vary, it may be desirable for card 80 to be approximately the size of a typical credit card to allow consumers to conveniently carry card 80 with them as they shop. Merchants may even opt to dispose infant clothing size chart 26 on their store credit cards or gift cards. Furthermore, portable card 80 is small enough that it may also be mailed with baby shower invitations to assist potential gift purchasers in selecting properly sized clothing.

As suggested by FIGS. 1 and 2, infant clothing size chart 26 may be disposed on a variety of carriers of different size, shape, and material composition, but it will still meet the primary goal of conveniently aiding consumers of infant clothing by relating clothing size to season, based on the infant's birth date (or expected birth date).

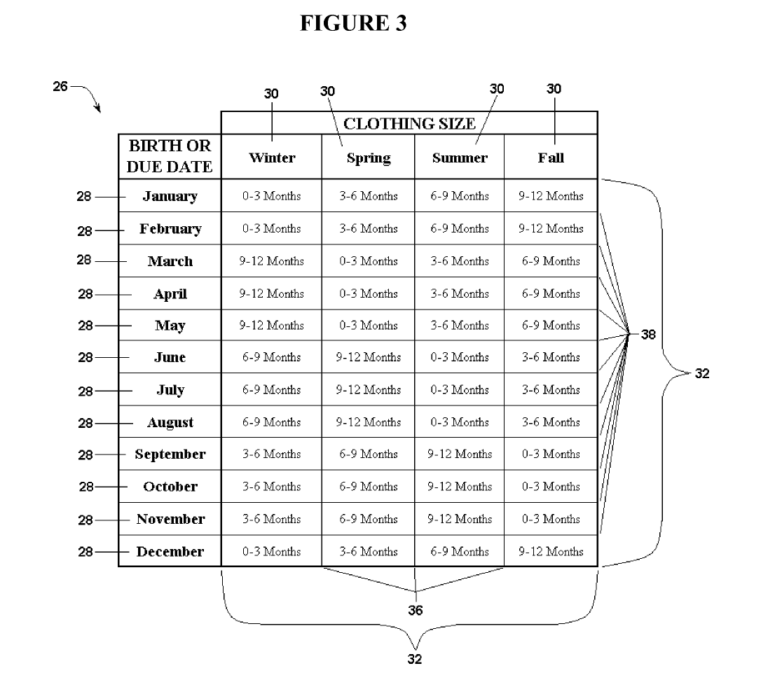

FIG. 3 illustrates an embodiment of infant clothing size chart 26 in which a user can cross-reference one of a plurality of rows 28 representing the infant's birth date (or expected birth date) against one of a plurality of columns 30 representing a meteorological season of interest, to find a single point, or cell, of intersection from a plurality of potential points, or cells, of intersection 32. The single point, or cell, of intersection indicates the correct infant clothing size to be purchased based on the user-defined birth date and meteorological season. To make sizing chart 26 easier to read, plurality of rows 28 may be defined by a plurality of horizontal lines of demarcation 38, and plurality of columns 30 may be defined by a plurality of vertical lines of demarcation 36. The intersecting horizontal and vertical lines of demarcation, 38 and 36, respectively, then define the cells of intersection. Each cell of intersection includes indicia of an infant clothing size (e.g., 0-3 months, 3-6 months, etc.) For purposes of the subject invention, the infant's birth month or expected month of birth may suffice for the birth date or expected birth date. Furthermore, each row typically includes a label, or indicia, corresponding to a date, or month of birth (e.g., January, February, March, etc.), and each column typically includes a header indicia corresponding to a meteorological season (e.g., winter, spring, summer, or fall). As described, infant clothing size chart 26 of FIG. 3 is useful when the consumer knows the infant's birth date (or expected birth date) and the season she would like to purchase the clothing for but does not know which clothing size to purchase.

For an example of a method of using the infant clothing size chart 26 of FIG. 3, one can assume that a consumer is searching for Spring clothing for an infant born (or expected to be born) in the month of October. The consumer would follow the row corresponding to the October entry horizontally across to the right of the month label and the column corresponding to Spring vertically down below the season label, until the row and column intersect. In this example, the point, or cell, of intersection indicates that clothing sized 6-9 Months should be purchased.

The example charts shown herein are based on meteorological seasons of Spring including the months of March, April, and May, Summer including June, July, and August, Fall including September, October, and November, and Winter including the months of December, January, and February, but these are only examples. It will be appreciated by those of ordinary skill in the art that the specific dates corresponding to each season can be varied as desired. Furthermore, the examples show infant clothing sizes up to 12 months, but it will be appreciated by those of ordinary skill in the art that clothing sizes for children older than 12 months may also be included. Finally, for purposes of this invention, the infant's birth date or expected birth date may be expressed only as birth month or expected birth month.

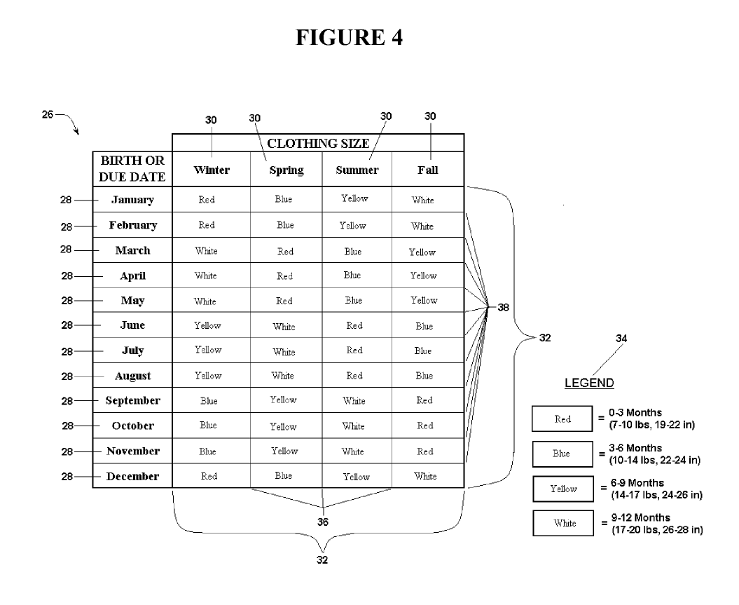

The infant clothing size chart 26 of FIG. 4 is nearly identical to the chart shown in FIG. 3, but in this embodiment, the points, or cells, of intersection 32 are color coded based the clothing size. Thus, the text shown in the points, or cells, of intersection 32 of FIG. 2 are replaced in FIG. 3 by shaded boxes. A Legend 34 may also be used in conjunction with chart 26 to indicate which color corresponds to which clothing size. Furthermore, as shown in Legend 34, it may also be desirable to relate clothing size to the length and weight of the infant, for those consumers that know the physical size of the infant. Although not shown in sizing chart 26 of FIG. 3, it may be desirable to include a similar notation relating the clothing size based on age to the size of the infant in the points, or cells, of intersection. Generally, the more information a consumer has available, the better her decision will be.

Using the same example as above will illustrate a method of using infant clothing size chart 26 of FIG. 4. Again, if a consumer is searching for Spring clothing for an infant born (or expected to be born) in the month of October, the consumer would follow the row corresponding to the October entry horizontally across and the column corresponding to Spring vertically down until the row and column intersect. In this example, the point, or cell, of intersection is a Yellow shaded box. Legend 34 indicates that a Yellow shaded box corresponds to clothing sized 6-9 Months. Thus infant clothing sized 6-9 Months (for an infant approximately 24-26 inches long and weighing 14-17 pounds) should be purchased.

It may also be desirable to use text, as shown in FIG. 3, and colored shading, as illustrated in FIG. 4, in combination with each other to make chart 26 easier to read and understand. This combination of text and color would also allow for the elimination of Legend 34.

Furthermore, it may be desirable to mark each label or tag associated with an article of infant clothing with a color that matches the clothing size color of Legend 34. Thus, once a consumer uses size chart 26 of FIG. 4 to find the cell, or point, of intersection, she need only look for a clothing tag or label marked with a color corresponding to the cell, or point, of intersection. In this manner, a consumer can find the appropriately sized clothing without the use of legend 34 and without the need to search for and read the clothing size marked on the clothing tags or labels. Consistently color-coding the clothing tags or labels with the colors of infant clothing size chart 26 of FIG. 4 can make shopping for infant clothing even easier and quicker.

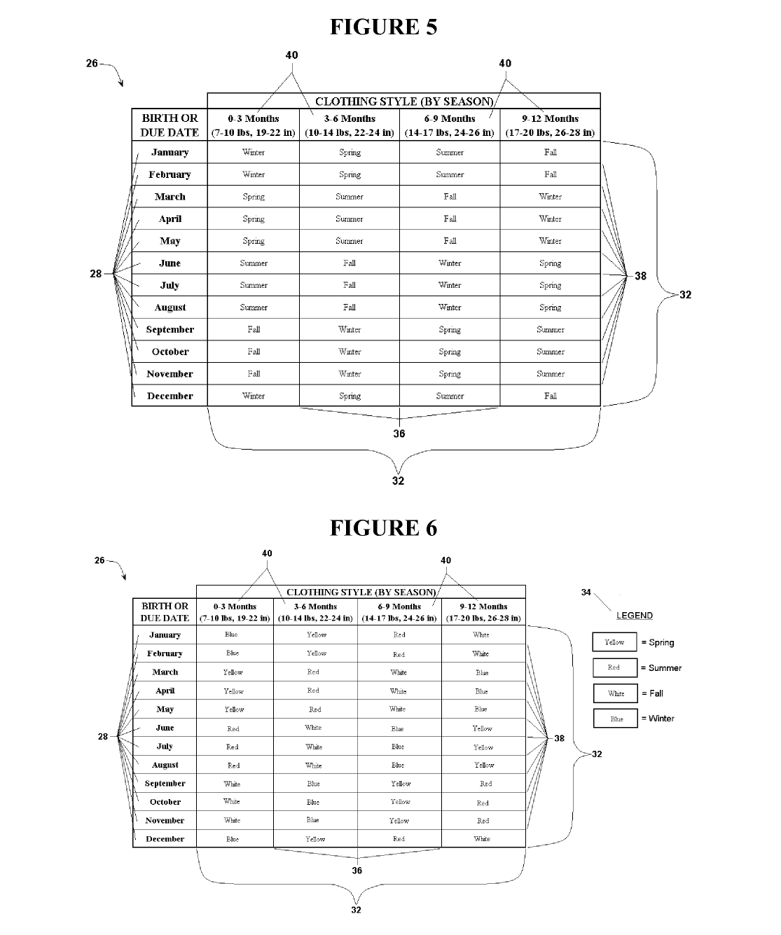

FIG. 5 illustrates an embodiment of infant clothing size chart 26 that is similar to the embodiment of FIG. 3, but in this version, a user can cross-reference one of a plurality of rows 28 representing the infant's birth date (or expected birth-date) against one of a plurality of columns 30 representing an infant age (or clothing size), to find a single point, or cell, of intersection from a plurality of potential points, or cells, of intersection 32. The single point, or cell, of intersection indicates the correct meteorological season for which clothing of the user-defined size should be purchased for. To make sizing chart 26 easier to read, plurality of rows 28 may be defined by a plurality of horizontal lines of demarcation 38, and plurality of columns 30 may be defined by a plurality of vertical lines of demarcation 36. The intersecting horizontal and vertical lines of demarcation, 38 and 36, respectively, then define the cells of intersection. Each cell of intersection includes indicia representing the season for which clothing should be purchased (e.g., winter, spring, summer, fall). Furthermore, each row typically includes a label, or indicia, corresponding to a date, or month of birth (e.g., January, February, March, etc.), and each column typically includes a header indicia corresponding to an infant clothing size (e.g., 0-3 months, 3-6 months, etc.). As described, infant clothing size chart 26 of FIG. 5 is useful when the consumer knows the infant's birth date (or expected birth date) and the size of the clothing to be purchased but does not know which season to purchase the clothing for.

An example of a method of using infant clothing size chart 26 follows: if a consumer is searching for clothing for a 6-9 month old infant born (or expected to be born) in the month of April, the consumer would follow the row corresponding to the April entry horizontally to the right of the month label and the column corresponding to 6-9 months vertically down, until the row and column intersect. In this example, the point, or cell, of intersection indicates that Fall clothing should be purchased.

As shown in FIG. 5, it may be desirable to include a notation that relates the infant's physical size (length and weight) to the clothing size, as the physical size of infants in the same age range can vary widely.

FIG. 6 shows an embodiment of infant clothing size chart 26 that is similar to the embodiment of FIG. 4, but in this version, a user can cross-reference one of a plurality of rows 28 representing the infant's birth date (or expected birth-date) against one of a plurality of columns 30 representing a clothing size of interest, to find a single point, or cell, of intersection from a plurality of potential points, or cells, of intersection 32.

Using the same example as used in conjunction with the chart of FIG. 5 will illustrate a method of using infant clothing size chart 26 of FIG. 6. Again, if a consumer is searching for clothing for a 6-9 month old infant born (or expected to be born) in the month of April, the consumer would follow the row corresponding to the April entry horizontally to the right of the month label and the column corresponding to 6-9 months vertically down, until the row and column intersect. In this example, the point, or cell, of intersection is shaded White (or not shaded at all, in the case of white). Review of Legend 34 leads the consumer to conclude that White corresponds to Fall and indicates that clothing styled for Fall should be purchased.

It may also be desirable to use text, as shown in FIG. 5, and colored shading, as illustrated in FIG. 6, in combination with each other to make chart 26 easier to read and understand. This combination of text and color would also allow for the elimination of Legend 34.

Furthermore, it may be desirable to mark each label or tag associated with an article of infant clothing with a color that matches the seasonal clothing style color of Legend 34. Thus, once a consumer uses size chart 26 of FIG. 6 to find the cell, or point, of intersection, she need only look for a clothing tag or label marked with a color corresponding to the cell, or point, of intersection. In this manner, a consumer can find clothing for the appropriate season without the use of legend 34 and without the need to inspect the clothing for its seasonal style. Consistently color-coding the clothing tags or labels with the colors of infant clothing size chart 26 of FIG. 6 can make shopping for infant clothing even easier and quicker.

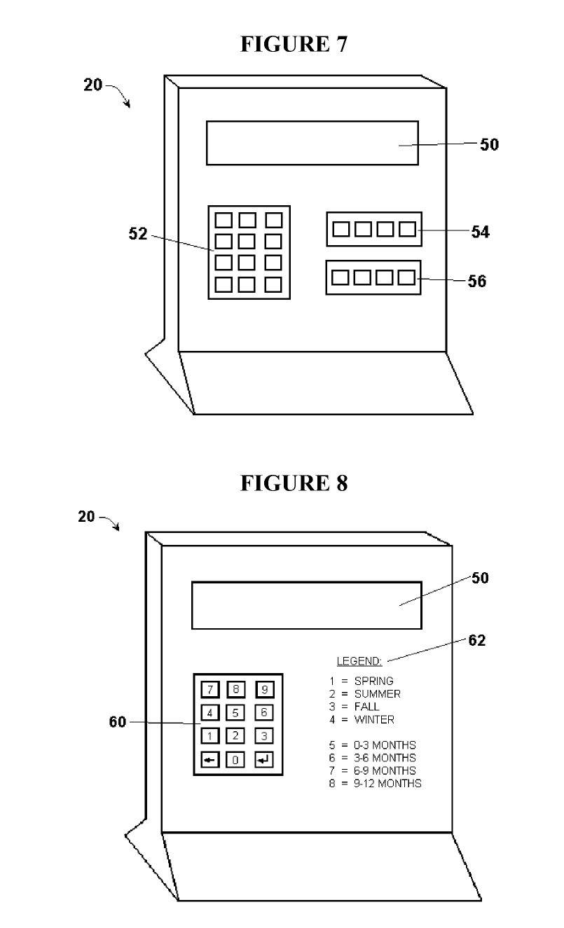

FIG. 7 illustrates another embodiment of a point-of-purchase device 20 that aids consumers of infant clothing by relating clothing size to season, based on the infant's birth date (or mother's due date). The device of FIG. 7 is an electronic device that may be similar to a traditional calculator, the construction of which is well known by those of ordinary skill in the art. Point-of-purchase device 20 of FIG. 7 includes a digital display 50 for communicating information to the consumer, an infant birth date input means 52, an infant age input means 54, and a meteorological season input means 56. Infant birth date input means 52 may include a set of keys or buttons, where each key or button corresponds to a birth month. Infant age input means 54 also typically includes a set of keys or buttons, where each key or button corresponds to an infant age range (e.g., 0-3 months, 3-6 months, 6-9 months, etc.). Similarly, meteorological season input means 56 may include a set of keys or buttons, where each key or button corresponds to a season (e.g., winter, spring, summer, fall).

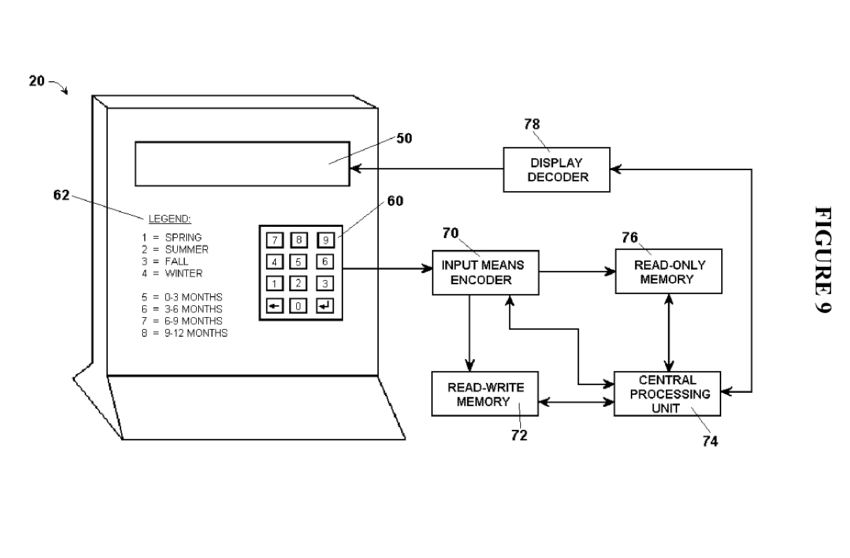

FIG. 8 illustrates a point-of-purchase device 20 that is similar to the device of FIG. 7 but has only a single input means 60. Input means 60 is similar to a keypad of a calculator or to a numeric keypad of a computer keyboard. Point-of-purchase device 20 of FIG. 8 may also include a Legend 62 disposed on the front of the device to communicate to the user what each key represents. Input means 60 allows a user to input an infant's birth date, the meteorological season of interest, and the infant clothing size of interest, all with a single keypad.

FIG. 9 illustrates a block diagram of point-of-purchase device 20 wherein the input means described above (e.g., 60) initiates the performance of various computational and manipulative operations. The input means is connected to input means encoder 70, which generates various key codes in response to the depression of the various keys on the input means. Input means encoder 70 is connected to a read-only memory (ROM) 76 and central processing unit (CPU) 74. ROM 76 contains instructions that correspond to the various key codes generated by input means encoder 70. CPU 74 responds to the instructions from ROM 76 to perform various manipulative operations on data entered via the input means. The operation of such ROM and CPU along with a keypad and related circuits are known to those of ordinary skill in the art and will not be described here.

Point-of-purchase device 20 of FIG. 9 also includes a read-write memory 72 that is also connected to input means encoder 70 and CPU 74. Read-write memory 72 may be used for storing information entered from the input means. The key codes stored in read-write memory 72 are data stored in coded form for later use by a program stored in ROM 76. Based on data entered by the user and on the program saved in ROM 76, CPU will trigger display encoder 78 to communicate information to the user via display 50.

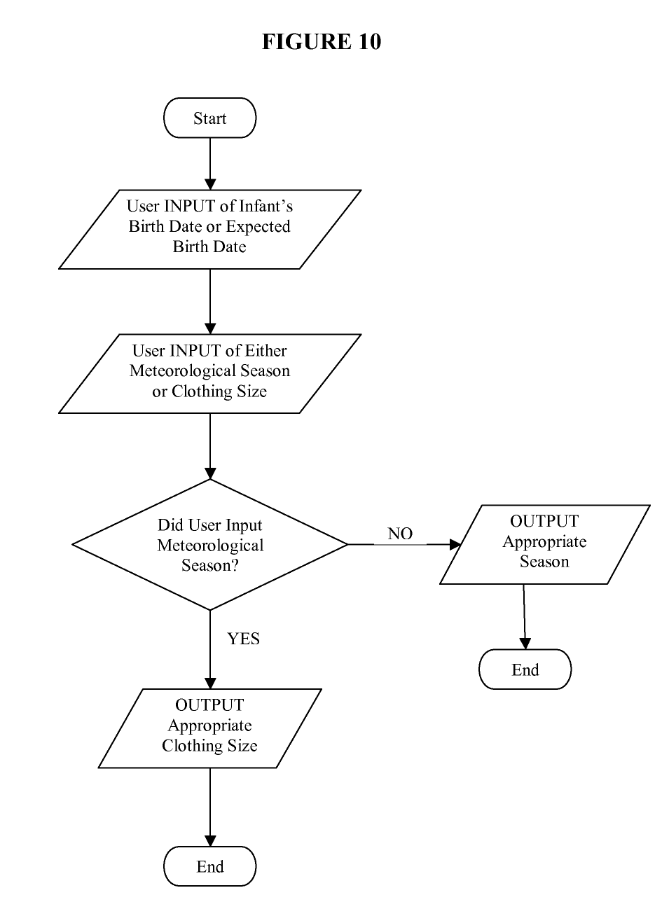

FIG. 10 illustrates a flowchart of the operation of point-of-purchase device 20 of FIGS. 7-10. The device typically begins with a message displayed on display 50, such as “ENTER INFANT'S BIRTH MONTH.” The consumer would then use input means 52 or 60 to enter the infant's month of birth or expected month of birth. This information would be encoded by input means encoder 70 and temporarily stored in read-write memory 72. A program stored in ROM 76 then communicates to CPU 74 to trigger display decoder 78 to prompt the user (via display 50) to input either the clothing size (infant age range) or meteorological season of interest. The user then inputs the requested information via input means 54, 56, or 60, and the data is stored in another section of read-write memory 72. If the user enters the meteorological season, then the program stored in ROM triggers the CPU to manipulate the birth date and season data and output the appropriate clothing size on display 50. If the user enters the clothing size (infant age range, e.g., 0-3 months, 3-6 months), then the program stored in ROM triggers the CPU to manipulate the birth date and clothing size data and output the appropriate season for which to buy clothing on display 50. In this manner, point-of-purchase device 20 of FIGS. 7-10 receives certain data from the consumer related to the infant's birth date and either clothing size or seasonal clothing style, manipulates that data and then communicates either the appropriate size or season for which to purchase infant clothing.

Although the invention is described with respect to a preferred embodiment, modifications thereto will be apparent to those of ordinary skill in the art. For example, the infant clothing size chart of FIGS. 1-6 is shown with data corresponding to the infant's birth date entered in rows and data corresponding to the meteorological season or clothing size entered in columns. However, it is well within the scope of the invention to reverse this configuration such that the data corresponding to the infant's birth date is entered in columns and data corresponding to season or clothing size is entered in rows. Furthermore, the apparatus of FIGS. 7-10 is described as using a graphical display to communicate to the user, but it is well within the scope of the invention to use audible means of communication rather than a graphical display. Therefore, the scope of the invention is to be determined by reference to the following claims.

We claim:

1. A method of determining the appropriate infant clothing size by using a chart that comprises a plurality of rows, each row corresponding to an infant's birth date or expected birth date, a plurality of columns, each column corresponding to a meteorological season, a plurality of data points corresponding infant clothing sizes, wherein each data point is an intersection between one of the plurality of rows and one of the plurality of columns, the method comprising:
identifying the row corresponding to the infant's birth date or expected birth date on the chart;
identifying the column corresponding to the meteorological season for which clothing is desired on the chart;
following the row across and the column down until a point of intersection is reached; and
ascertaining the infant clothing size from the point of intersection.

2. The method of claim 1, wherein the chart's data points are colored and the chart includes a legend that relates a data point color to an infant clothing size, wherein ascertaining the infant clothing size includes cross-referencing the data point color with the legend to determine the appropriate infant clothing size.

3. The method of claim 1, wherein the data points associated with a particular clothing size are shaded a first color, the method further comprising:
matching the first color to a second color marked on a tag attached to an article of infant clothing.

4. A method of determining the appropriate meteorological season for which to purchase infant clothing by using a chart that comprises a plurality of rows, each row corresponding to an infant's birth date or expected birth date, a plurality of columns, each column corresponding to an infant clothing size, a plurality of data points corresponding to meteorological seasons, wherein each data point is an intersection between one of the plurality of rows and one of the plurality of columns, the method comprising:
identifying the row corresponding to the infant's birth date or expected birth date on the chart;
identifying the column corresponding to the infant clothing size of interest on the chart;
following the row across and the column down until a point of intersection is reached; and
ascertaining the meteorological season for which to purchase clothing from the point of intersection.

5. The method of claim 4, wherein the chart's data points are colored and the chart includes a legend that relates a data point color to a meteorological season, wherein ascertaining the meteorological season includes cross-referencing the data point color with the legend to determine the appropriate meteorological season for which to purchase clothing.

6. The method of claim 4, wherein the data points associated with a particular clothing size are shaded a first color, the method further comprising:
matching the first color to a second color marked on a tag attached to an article of infant clothing.

7. A method of aiding a consumer of infant clothing in the selection of the correct sized clothing for a meteorological season of interest, the method comprising:
receiving consumer input of the infant's birth date or expected birth date;
temporarily storing the infant's birth date or expected birth date;
receiving consumer input of the meteorological season of interest;
determining the age of the infant during the meteorological season of interest; and
communicating to the consumer the infant clothing size that corresponds to the age of the infant.
